(19) United States
(12) Patent Application Publication
(10) Pub. No.: US 2026/0040425 A1
(43) Pub. Date: Feb. 5, 2026

(54) NUCLEAR WEAPON EFFECTS TEST CAPABILITY USING HIGH-POWERED LASER

(71) Applicant: XCIMER ENERGY, INC., Redwood City, CA (US)

(72) Inventors: John Franklin Davis, III, Alexandria, VA (US); Victor Paul Karpenko, Livermore, CA (US); Robert Alan Lundy, Half Moon Bay, CA (US); Michael Timothy Tobin, Alexandria, VA (US)

(21) Appl. No.: 18/680,728

(22) Filed: May 31, 2024

Related U.S. Application Data
(60) Provisional application No. 63/505,895, filed on Jun. 2, 2023.

(51) Int. Cl. H05G 2/00

(52) U.S. Cl. CPC H05G 2/0084; H05G 2/0086

(57) ABSTRACT

Embodiments described herein cover systems and methods to generate a high-powered laser beam, direct the high-powered laser beam to be incident upon a source material, wherein the source material generates X-ray radiation upon being energized by the high-powered laser, and provide one or more components of a test system positioned to receive the X-ray radiation generated from the source material.

### RELATED APPLICATIONS

This application claims benefit of provisional U.S. Patent Application No. 63/505,895, filed on Jun. 2, 2023, which is herein incorporated by reference in its entirety.

### FIELD

The present invention relates to testing of effects of nuclear weapon environments on systems, and in particular, to testing nuclear weapons effects using a high-powered laser to generate nuclear weapons test environments.

### INCORPORATION BY REFERENCE

All publications and patent applications mentioned in this specification are incorporated herein, in their entirety, by reference to the same extent as if each individual publication or patent application was specifically and individually indicated to be incorporated by reference.

### BACKGROUND

Nuclear weapons can produce a wide variety of environments to include blast, thermal, neutron, gamma, X-rays and high altitude electro-magnetic pulses. Determining that a system is survivable in a nuclear environment requires a combination of analysis, modeling and simulation, and testing. This is done in a logical process to successively higher levels of integration, beginning with response of piece-parts and components, and progressing to circuit boards, integrated sub-systems, and systems. Traditionally, tested sub-systems and full systems have been tested using environments produced by nuclear weapons in underground effects testing (UGET).

### BRIEF DESCRIPTION OF THE DRAWINGS

FIG. 1 depicts a system for nuclear weapon effects testing using a high-powered laser, according to embodiments of the present disclosure.

FIG. 2 depicts an example of an array of X-ray sources using a high-powered laser for nuclear system effects testing of a system, according to embodiments of the present disclosure.

FIG. 3 depicts a diagram of example test areas versus X-ray fluence levels for “Cold” (0.1-10 keV) X-ray testing levels generated using a high-powered laser, according to embodiments of the present disclosure.

FIG. 4 depicts a diagram of example test areas versus X-ray fluence levels for “Warm” (˜15-25 keV) X-ray testing levels generated using a high-powered laser, according to embodiments of the present disclosure.

FIG. 5 depicts a diagram of example test areas versus X-ray fluence levels for “Warm/Hot” X-ray (25-100 keV) testing levels generated using a high-powered laser, according to embodiments of the present disclosure.

FIG. 6 depicts a flow diagram illustrating an example method of using a high-powered laser for nuclear weapon effects testing, according to embodiments of the present disclosure.

FIG. 7 depicts an example radiation composition of a nuclear event, according to embodiments of the present disclosure.

FIG. 8 depicts types of effects on a system within a radiation spectrum, according to embodiments of the present disclosure.

FIG. 9 depicts example effects on a system associated with various radiation energies, according to embodiments of the present disclosure.

FIG. 10 depicts example source materials and their corresponding X-ray emission spectrums, according to embodiments of the present disclosure.

FIG. 11 depicts an example metallic foam as a source material to generate X-rays, according to embodiments of the present disclosure.

FIG. 12 depicts an example of an array of X-ray sources for radiation effects testing of a system, according to embodiments of the present disclosure.

FIG. 13 depicts an array of four independent X-ray point sources for radiation effects testing, according to embodiments of the present disclosure.

FIG. 14 depicts an example depth-dose profile of X-radiation on aluminum with the possible result to blowoff surface material and produce shock and impulse, according to embodiments of the present disclosure.

FIG. 15 depicts an example configuration for testing structural response as a result of X-ray irradiation on an aluminum ring, according to embodiments of the present disclosure. TWCP (Tape Wound Carbon Phenolic) is a generic material used as a heat shield to protect an exo-atmospheric system during re-entry into the earth's atmosphere.

FIG. 16 depicts an example strain profile of thermo-structural response level radiation on aluminum ring, according to embodiments of the present disclosure. TSRTk (Thermos-Structural Response Toolkit) is a modeling and simulation code used to model radiation effects on structures.

FIG. 17 depicts an example of the mechanisms that produce system generated electro-magnetic pulse from high energy incident X-rays, according to embodiments of the present disclosure.

FIG. 18 depicts example laser to X-ray conversion efficiencies (XRCE) versus X-ray energies from various X-ray sources that are producible by the National Ignition Facility (NIF) laser, according to embodiments of the present disclosure.

FIG. 19 depicts a system for nuclear weapon effects testing using a distributed array of X-ray sources energized by a high-powered laser, according to embodiments of the present disclosure.

### DETAILED DESCRIPTION

The following description sets forth numerous specific details such as examples of specific systems, components, methods, and so forth, in order to provide a good understanding of embodiments of the present invention. It will be apparent to one skilled in the art, however, that at least some embodiments of the present invention may be practiced without these specific details. In other instances, well-known components or methods are not described in detail in order to avoid unnecessarily obscuring the description of the exemplary embodiments. Thus, the specific details set forth are merely exemplary. Particular implementations may vary from these exemplary details and still be contemplated to be within the spirit and scope of the present invention.

Nuclear weapons defense systems include systems and operations that are intended to protect against nuclear threats which are becoming more pertinent as additional nations become nuclear and strategic competitors. Such nuclear weapons defense systems include ground-launched inter-continental ballistic missiles (ICBM's), submarine launched ballistic missiles (SLBM's), satellites, missile defense systems, and other space assets. These systems must be able to perform their mission even as an adversary utilizes defense systems that include exo- and endo-atmospheric nuclear weapons. Accordingly, the efficacy of these systems requires investing in new research, prototyping, and engineering efforts that can be leveraged as needed to ensure a safe, secure, and effective nuclear deterrent.

One area of systems testing that is lacking in conventional methods includes large area X-ray effects testing of strategic system, e.g. re-entry vehicles (RV's) and re-entry bodies (RB's), in relevant exo-atmospheric nuclear environments. These test environments include blowoff-impulse & shock (BIS), thermo-mechanical effects (TME). and internal system generated electro-magnetic pulse (SGEMP).

BIS may include lower energy radiation affecting an outer layer of a system, such as a shell, cover, etc. “Warm” radiation of higher energy may cause TME which includes effects on internal mechanical structures of a system. “Warmer”/hot radiation of even higher energy may cause SGEMP which may include effects on the electrical components of the system.

Recent developments in laser technology have given rise for the potential of a new nuclear weapon effects test (NWET) capability that could reduce and/or eliminate these test shortfalls. The development of a low-cost laser with significant (>10×) increase in laser energy and power (e.g., more than 2 to 12 times the world's current largest laser system capabilities) allows the potential of a system to address these test shortfalls. A high energy laser, as discussed herein, may be a high energy laser as described by U.S. Pat. No. 10,170,883 B1, U.S. Pat. No. 10,770,860 B2, or U.S. Pat. No. 10,862,260, each of which are incorporate by reference herein.

Determining that a system is survivable in a nuclear environment requires a combination of analysis, modeling and simulation, and testing. This is done in a logical process to successively higher levels of integration, beginning with response of piece-parts and components, and progressing to circuit boards, integrated sub-systems, and systems. Previous tested sub-systems and full systems were tested in environments produced by nuclear weapons in the underground effects test program (UGET). Even with extensive modeling and simulation, analysis, and above ground radiation testing being performed, UGET's identified effects that were unknown and unforeseen (e.g., unforeseen mechanical and electrical effects on a system) by such modeling, simulation, and analysis. However, underground nuclear testing was ceased in accordance with the implementation of the Comprehensive Nuclear-test Ban Treaty. The absence and end of underground testing has left a gap in X-ray testing and certification that has yet to be remedied, even with the advent of high-performance computing capable of three-dimensional systems modeling. Because X-ray interactions with systems as they are actually built are complex, simulations must be validated by physical testing to account for any unforeseen or unpredictable effects on a system. Accordingly, systems and methods are needed to test national security systems at the system level (i.e., the highest level of integration) as well as the individual sub-systems in high fidelity X-ray test environments. This means testing system and system parts to fluence levels, spectral values, and time duration that are traceable to or can be extrapolated to nuclear threats (e.g., a nuclear weapons environment).

The technology for laser driven X-ray sources is well understood and mature. Now, with the potential of a very high-power laser (up to 24 Megajoules (MJ)), it is possible to produce X-rays over a range of X-ray energies and with sufficient output to allow testing of large systems to X-ray effects. Test protocols have been identified for effective testing over a range of X-ray fluences for three different test scenarios. First, to produce “Cold” X-rays (order of 0.1-10 keV) to test for effects due to blow-off impulse and shock, second to produce “Warm” X-rays (order of 15-25 keV) to test for thermo-mechanical effects and third to produce “Warm/Hot” X-rays (order of 20-100 keV) to test for effects due to system generated electro-magnetic pulse. (SGEMP).

In the following description and in the accompanying drawings, specific terminology and reference numbers are set forth to provide a thorough understanding of embodiments of the present invention. In some instances, the terminology and symbols may imply specific details that are not required to practice the invention.

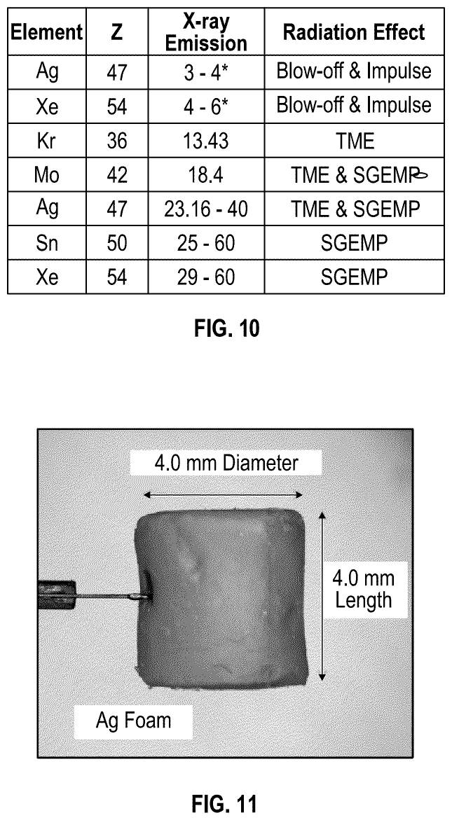

FIG. 1 depicts a system for nuclear weapon effects testing using a high-powered laser, according to some embodiments. As depicted, the system includes a laser source 110 to generate a laser beam directed at an X-ray source material 115. The laser source 110 may be a high-powered laser source such as a Krypton Fluoride (KrF) laser or other excimer laser with an output power of up to 24 MJ. The power of the laser beam may be adjustable to a power level corresponding to a level of component or system testing. In some examples, the X-ray source material 115 may also be a material that produces X-rays upon being illuminated with a laser beam. The X-ray source material 115 may be selected based on the energy of the desired output X-rays. For example, the X-ray source material 115 may be one of the materials provided in FIG. 10 and produce X-rays with the corresponding energies depicted in FIG. 10. The resulting X-rays produces by the X-ray source material 115 may be directed at a test object 120 for determining whether a design of the test object 120 can survive, or how long the test object 120 can survive, under various conditions produced by nuclear weapons.

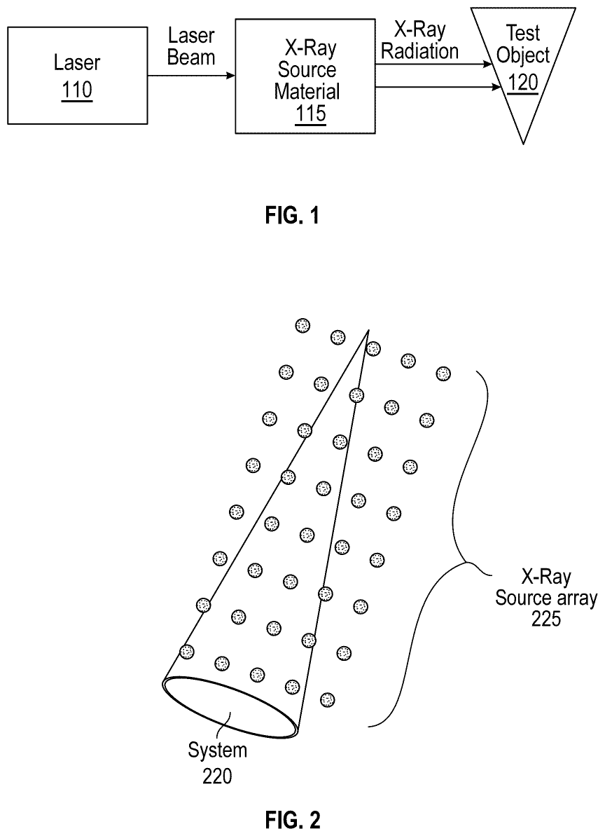

FIG. 2 depicts an array of independent laser X-ray sources according to embodiments of the present disclosure. An X-ray source array 225 can be provided by separating a high energy laser beam into multiple high energy laser beams. Each laser beam can then be directed at one of a distributed array of X-ray sources (e.g., X-ray source materials). The impact of each laser beam at each of the several sources can produce corresponding X-rays. As described above, the X-ray energy generated by the laser incident upon the source depends on the energy of the laser and the source material.

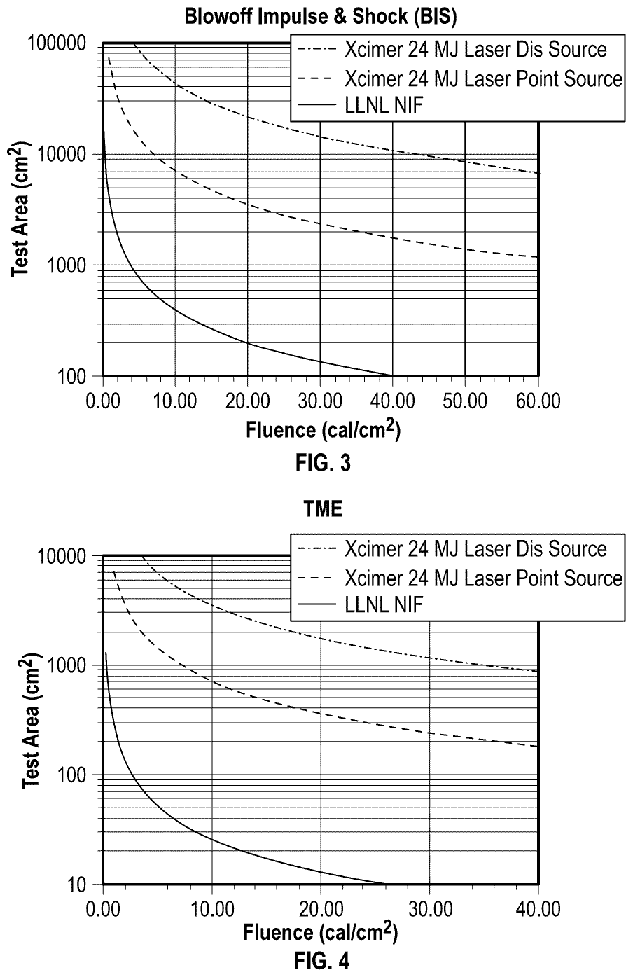

The separation of the incident laser beam into multiple, independent laser X-ray sources, may result in a source array that approaches emission from a distributed array, thereby allowing more of the X-ray output from the sources to be incident on the test object (e.g., system 220) and thus increasing the test area (typically order of 3-5×) for a given fluence. Adequate range of test environments for large strategic systems may not be possible using a point source of X-rays even with the very large laser identified above. However, by using an array of distributed X-ray sources 225 as shown in FIG. 2, full system testing may be performed over a very useful range of fluences (see FIG. 3). This potential test capability using the proposed high power laser rivals test capabilities what was lost with UGETs with the added advantage of much lower cost per shot, much higher shot rate, and with reproducible environments.

The potential radiation effects test capability of the proposed high-power laser system for blow-off impulse and shock testing utilizes source materials that are known to produce 0.1 to 10 KeV X-rays. For example, the source material may include the use of small thin plastic cylinders (order of 4×6 mm) containing a mixture of argon and xenon gas at approximately one atmosphere. Theory and experiments have shown that these X-ray sources are predictable and have remarkably high conversion efficiency of incident laser energy to X-ray output of ˜ 35% in the range of 0.1-10 keV. FIG. 3 shows the potential test area versus fluence, using the laser produced X-ray sources discussed above and assuming a fluence uniformity over the test object of 80% (+10%).

The black curve depicted in FIG. 3 shows the existing test capability using the current largest laser system available. The 24 MJ Laser Point Source curve shows the potential capability of using a high-powered (e.g., 24 MJ) laser system, assuming the sources are represented as a point source with the fluence at the test object falling off as 1/r² versus the distance from the source. Most advantageously, the 24 MJ Laser Distributed Source curve shows the potential capability of the proposed high-powered laser system used with an array of sources to produce an array of X-ray point sources. As can be seen, the array of X-ray sources provides an order of 140 times the existing test capabilities and allows testing over a range of fluences to allow low uncertainty extrapolation to full system responses for assessment of strategic system survivability.

FIG. 4 illustrates the test area versus fluence for different sources that can produce higher energy X-ray environments (“Warm” X-rays), according to embodiments. As described above, testing for thermo-mechanical effects (TME) requires “Warm” X-ray energies of order 15-25 KeV. In some embodiments, these X-ray energies are provided using laser driven X-ray sources with source materials of metallic foams (e.g., comprised of copper, molybdenum or silver). Such sources enable the high-power laser system to efficiently heat the source material to temperatures necessary to radiate “Warm” X-ray energies. Even with a high energy laser, X-ray sources that produce these energies are not very efficient, and a conservative laser to X-ray conversion efficiency is ˜3.5%.

FIG. 4 shows the potential test area versus fluence using these sources and assuming a fluence uniformity over the test object of 80% (+10%). The solid curve shows the existing test capability. The 24 MJ Laser Point Source curve shows the potential capability of the proposed 24 MJ laser system as a point source. The 24 MJ Laser Distributed Source curve represents a 24 MJ distributed array as discussed earlier. For “Warm” X-ray thermo-mechanical effects, the 24 MJ laser would support multiple test configurations. With the use of distributed sources, this is >100 times greater than existing/planned test capabilities and provides more accurate testing to support the validation of modeling and simulation results. The proposed 24 MJ laser with a 12-source array allows for X-ray effects testing of instrumented test objects over a range of fluences to allow low uncertainty extrapolation to full system responses for assessment of strategic system survivability.

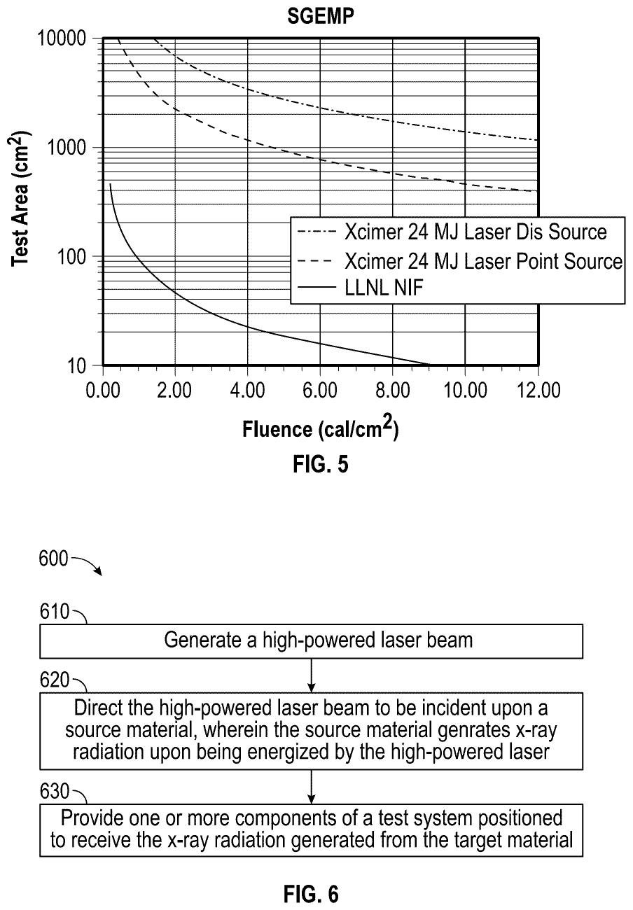

FIG. 5 illustrates the test area versus fluence for different sources with “Warm/Hot” X-ray energies, according to embodiments. As discussed above, the X-ray energies needed to drive System Generated Electromatic Pulse (SGEMP) effects are in the range of 20-100 keV. The results shown in FIG. 5 assume a laser driven copper foam X-ray source with a 1% conversion efficiency. SGEMP is and has been one of the most difficult X-ray effects to model and test. Laser driven X-ray sources for this regime are even less efficient than for the lower energy range. However, the use of a high energy laser may provide for higher electron temperatures in the sources and thereby increase the continuum radiation with an increase in test capability. “Warm/Hot” X-rays can penetrate and be absorbed into interior surfaces of systems to produce photo-electrons. These X-ray produced electrons stimulate electro-magnetic pulses capable of driving currents that can burn out cables and electronics.

FIG. 5 shows the potential test area versus fluence using a copper foam source and assuming a fluence uniformity over the test object of 60% (+20%), which is acceptable for SGEMP effects tests. The solid black curve shows the existing test capability at NIF. The 24 MJ Laser Point Source curve shows the potential capability of the proposed 24 MJ laser system assuming the sources are represented as a point source. The 24 MJ Laser Distributed Source curve assumes a distributed array as in FIG. 2. The proposed 24 MJ laser with a 12-source array allows for X-ray effects testing of instrumented test objects with relevant X-ray spectrum over a range of fluences to allow low uncertainty extrapolation to system response to assess strategic system survivability.

FIG. 6 depicts an example flow diagram of a method of using a high-powered laser for nuclear weapon effects testing, according to some embodiments. The method begins at block 610 where a high-powered laser beam is generated. The high-powered laser beam may be generated by a high-powered laser source such as a Krypton Fluoride laser. In some embodiments, the laser source intensity that is input onto the X-ray sources may be variable (e.g., 10\hat{ }13-10\hat{ }17 W/cm\hat{ }2). In some embodiments, the high-powered laser beam may operate at a wavelength in the range of 190-260 nanometers. In some embodiments, the high-powered laser beam may operate at a wavelength in the range of 247-250 nanometers.

At block 620, the high-powered laser beam is directed to be incident upon a source material, wherein the source material generates X-ray radiation upon being illuminated by the high-powered laser. The source material may be selected based on the type of test being performed. For example, for blowoff-impulse and shock testing the source material may be a mixture of argon and xenon gas. In some examples, for TME testing a metallic foam such as molybdenum or silver may be used as the source material and for SGEMP effects testing a copper or silver foam may be used for the source material. In some examples, the power of the laser may be varied depending on the tests being performed. For example, to produce “Warm/Hot” X-rays for SGEMP effects testing, the laser intensity and/or the laser pulse may be varied to more efficiently heat the source material to produce the “Warm/Hot” X-rays.

At block 630, one or more components of a test system are provided and positioned to receive the X-ray radiation generated from the source material. In some examples, individual components of the test system may be arranged in the X-ray radiation to test the effects on the induvial components. In some examples, a single X-ray source or an array of X-ray sources may be used to generate the X-ray radiation to test the individual components. In some examples, the entire system may be positioned in the radiation to test the effects on the test system as a whole.

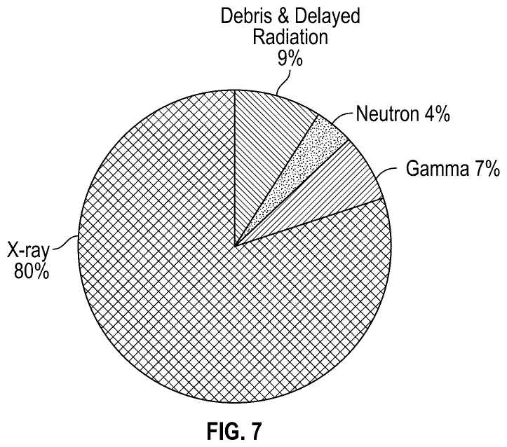

FIG. 7 depicts an example radiation composition of a nuclear event, according to embodiments of the present disclosure. As depicted, the largest output of a nuclear weapon may be X-rays (e.g., near 80%) with other forms of radiation such as gamma radiation, neutron radiation, and debris and delayed radiation making up the remaining 20%.

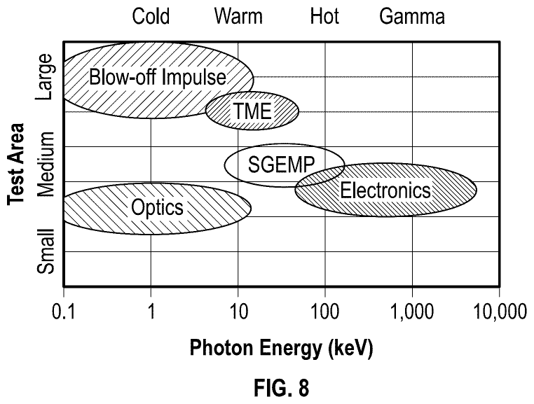

FIG. 8 depicts types of effects on a system within a radiation spectrum, according to embodiments of the present disclosure. As depicted, the blow-off impulse effects occur at lower photon energies (e.g., “Cold” X-rays), TME occurs at “Warmer” photon energies (e.g., above 8-10 keV), and SGEMP effects which may cause electronic effects occur at higher photon energies (e.g., above 20 keV).

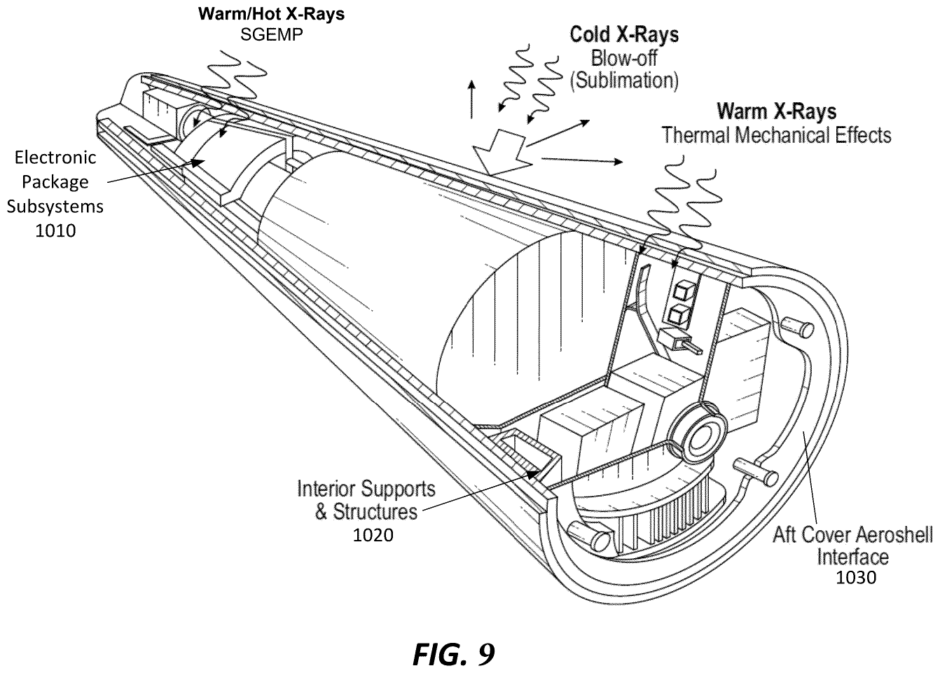

FIG. 9 depicts example effects on a system associated with various radiation energies, according to embodiments of the present disclosure. For example, the system may include a design for a re-entry vehicle or re-entry body. As depicted, “Cold” X-rays may affect an outer casing or heat shield of the system 1030. “Warm” X-rays may cause thermal mechanical effects on internal mechanical aspects of the system, such as interior supports and structures 1020. “Warmer/hot” X-rays may damage electronics package subsystems 1010, due to electro-magnetic pulse generation from X-rays impacting the system.

FIG. 10 depicts example source materials and their corresponding X-ray emission spectrums, according to embodiments of the present disclosure. Accordingly, the source materials may be selected for performing various levels of testing. In some examples, different source materials may be combined in an array to produce various levels of testing at one time.

FIG. 11 depicts an example metallic foam as a source material to generate X-rays, according to embodiments of the present disclosure. For example, the metallic foam may emit X-rays of a particular energy when a high energy laser is incident upon the metallic foam.

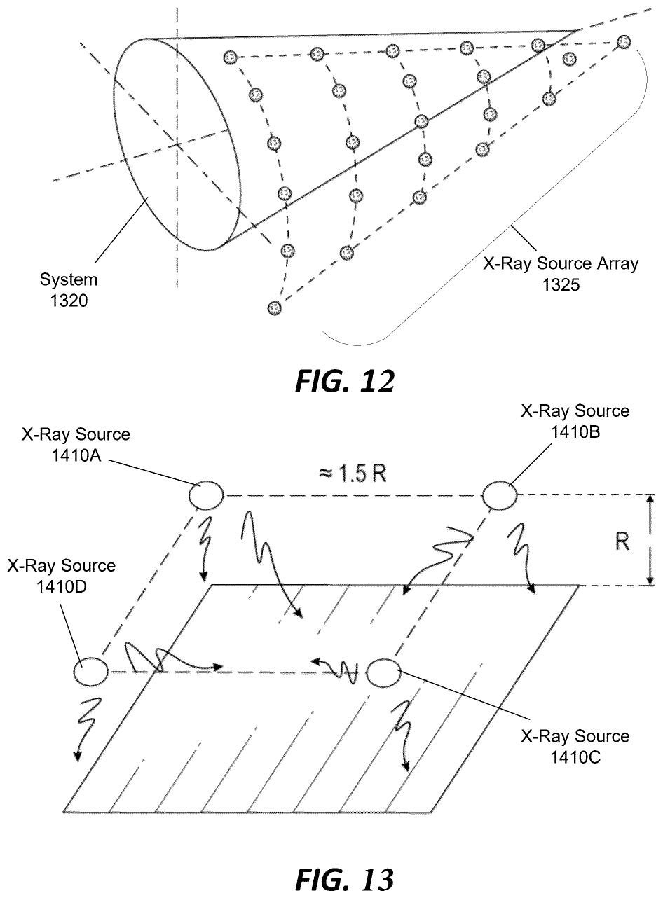

FIG. 12 depicts an array of X-ray sources for nuclear system effects test of a system, according to embodiments of the present disclosure. The array of X-ray sources 1325 may be arranged in a manner to provide a large test area to test entire integrated systems (e.g., system 1320). For example, as depicted, 24 laser X-ray sources may be distributed to achieve maximum fluence as well as maintaining uniformity across the target system. For example, the X-ray sources of the X-ray source array 1325 may be arranged according to the shape and size of the target system 1320, thus providing a uniform X-ray distribution and providing a maximum fluence to effectively test the entire system 1320.

FIG. 13 depicts an array of four independent X-ray point sources for nuclear system effects test of a system, according to embodiments of the present disclosure. As can be seen, the point sources 1410A-D can be arranged to provide a desired fluence and uniformity. A depth-dose at the X-ray incident angle may dictate the multiple source effective solid angle. Accordingly, the number and arrangement of X-ray sources can be changed or adjusted to provide sufficient coverage of the test system (e.g., such that the entire area or a desired area of the target system can be tested by the array.

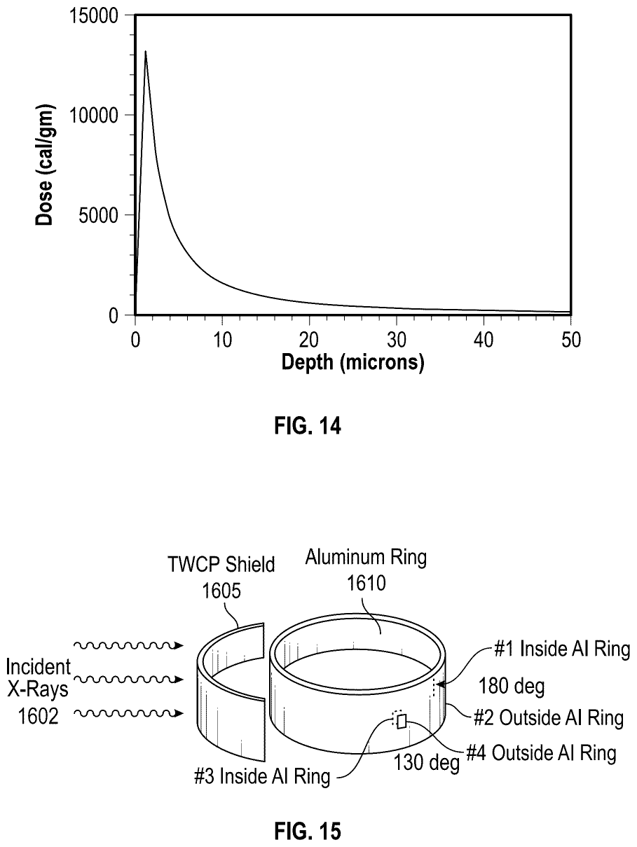

FIG. 14 depicts an example depth-dose profile of blowoff and impulse level radiation on aluminum, according to embodiments of the present disclosure. The depicted profile may result from X-ray energy deposited near a surface of the system. Surface material may be heated or vaporized which blows off and sends shock and impulse into the test object. Relevant radiation effects can be driven using line radiation with similar depth-dose profiles to that that which might be expected from a nuclear weapon. Strong shocks from blow-off and impulse can fracture and spall materials. Impulse can exceed plastic limits and deform materials.

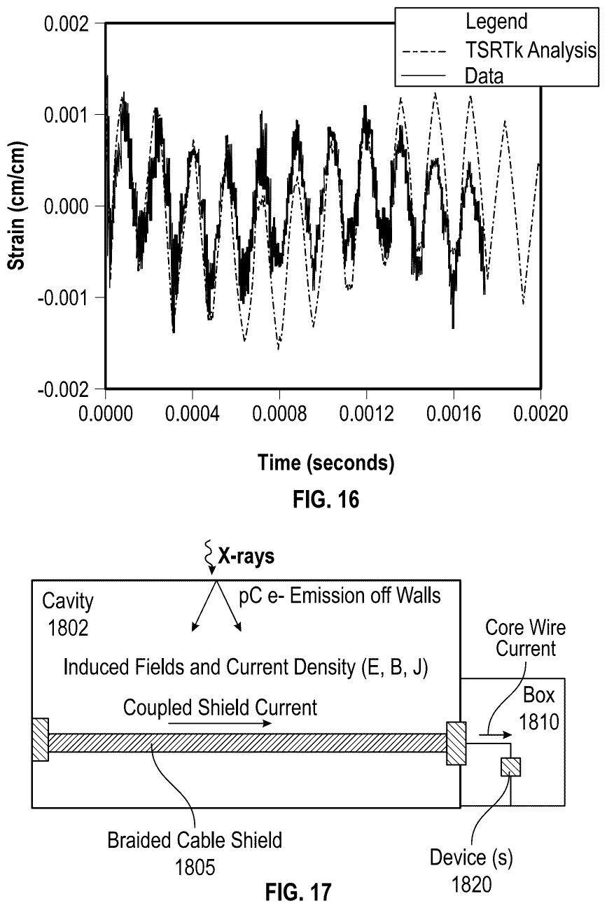

FIG. 15 depicts an example configuration for testing structural response level radiation on an aluminum ring, according to embodiments of the present disclosure. Incident X-rays 1602 may penetrate into the system to various depths. Higher X-ray energy may cause deeper penetration into the system. Short X-ray pulse length limits heat diffusion and material rapidly heats and expands (e.g., like ringing a bell). Accordingly, detectors or fibers can be positioned within a system (e.g., aluminum ring 1610) to determine the level of penetration and stress at various points in the system. For example, the detectors or fibers can be provided at various points inside and outside of the aluminum ring 1610 to detect thermal stress at those points. In some examples, a tape wound carbon phenolic material (TWCP 1605) represents a typical heat shield material that protects system during re-entry.) may be positioned prior to the aluminum ring 1610 in the path of the incident X-rays. FIG. 16 depicts an example of the temporal strain profile of thermo-structural response level radiation on an aluminum ring, according to embodiments of the present disclosure.

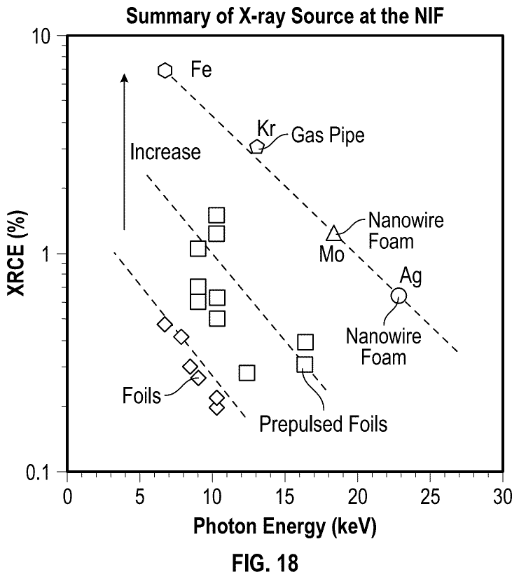

FIG. 17 depicts an example of the mechanisms that produce system generated electro-magnetic pulse from high energy incident X-rays, according to embodiments of the present disclosure. Warm/hot X-rays may penetrate in depth and produce photoelectric and Compton electrons. Electrons escaping into a vacuum cavity 1802 produce an electric field gradient (e.g., an electromagnetic pulse (EMP)). EMP in a cavity can produce currents in electronics and cables which may cause electrical shorts and burnouts. As depicted, the induced fields may be incident on electrical cables and cause electrical current that may damage devices 1820. Embodiments described herein may test systems designed to counteract these effects, such as braided cable shield 1805, box 1810, and designed of devices 1820. FIG. 18 depicts example X-ray energies from various X-ray sources that are producible by the National Ignition Facility (NIF) laser, according to embodiments of the present disclosure.

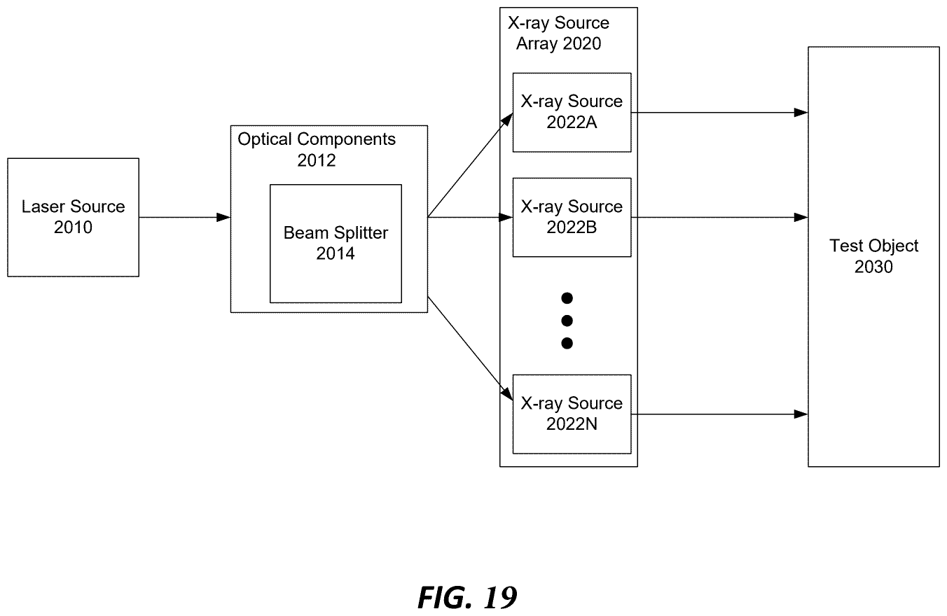

FIG. 19 depicts a system for nuclear weapon effects testing using a distributed array of X-ray sources energized by a high-powered laser, according to embodiments of the present disclosure. The system of FIG. 19 includes at least one laser source 2010. The laser source 2010 may be a high-powered laser source such as a Krypton Fluoride (KrF) laser with an output power of up to 24 MJ. The intensity of the laser beam may be adjustable to a power level necessary to produce X-rays for component or system testing. Optical components 2012 may direct the output laser beam to a plurality of X-ray sources 2022A-N in an X-ray source array 2020. For example, the optical components 2012 may include various lenses, mirrors, phase plates, etc. to direct the high-powered laser beam to the X-ray sources 2022A-N. In some examples, the optical components 2012 include one or more beam splitters 2014 to split the single high-powered laser beam into two or more high-powered laser beams, each directed by the optical components 2012 to a corresponding X-ray source 2022A-N, each to generate X-rays with an energy corresponding to the energy of the incident high-powered laser beams. The X-ray source array 2020 may thus provide a distributed fluence that encompasses the test object 230 or at a targeted portion of the test object 2030. Thus, the distributed X-ray source array 2020 may provide testing of the test object 2030 in nuclear weapons type environments.

In some examples, the X-ray sources 2022A-N may each include a material that produces X-rays upon being illuminated with a laser beam. The X-ray source material may be selected based on the energy of the desired output X-rays. For example, the X-ray source material may be one of the materials provided in FIG. 10 and produce X-rays with the corresponding energies depicted in FIG. 10. The resulting X-rays produced by the X-ray source 2022A-N may be directed at a test object 2030 for determining whether a design of the test object 2030 can survive, or how long the test object 2030 can survive, under radiation environments produced by nuclear weapons. In some embodiments, the test object 2030 may be positioned within a vacuum (e.g., a vacuum chamber) during testing.

The skilled artisan will appreciate that the embodiments described herein are made exemplary and not limiting. For example, fewer or more X-ray sources may be used and still fit within the scope of the present invention. Similarly, any number of laser sources and independent laser beams produced from those laser sources can be used to illuminate the X-ray sources. Similarly, various combinations of X-ray source materials may be used to produce combinations of the various energies of the X-rays at one time (e.g., to test when all of the above described effects occur at once).

It should be noted that the methods and systems described herein are not limited to use only in weapons effects testing. In alternative embodiments, the methods and apparatus herein may be used in applications outside of the weapons effects testing, such as testing of power generation equipment (e.g., nuclear power) or any other equipment stress testing or radiation exposure testing.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method of performing nuclear weapons effects testing comprising:
generating a high-powered laser beam;
directing the high-powered laser beam to be incident upon a source material, wherein the source material generates X-ray radiation upon being energized by the high-powered laser; and
providing one or more components of a test system positioned to receive the X-ray radiation generated from the source material.

2. The method of claim 1, further comprising:
separating the high-powered laser beam into a plurality of laser beams;
directing the plurality of laser beams toward a plurality of X-ray producing sources, to generate X-ray radiation from each of the plurality of sources, and
positioning the entire test system to receive the X-ray radiation generated by the plurality of sources.

3. The method of claim 1, wherein the high-powered laser is produced by a krypton fluoride laser system.

4. The method of claim 1, wherein the source material comprises at least one of a mixture of one or more noble gases or a metallic foam.

5. The method of claim 1, wherein the high-powered laser comprises a wavelength in the range of 190-260 nanometers.

6. The method of claim 1, wherein the high-powered laser comprises a wavelength in the range of 247-250 nanometers.

7. A system comprising:
a laser source to generate a high-powered laser beam;
an X-ray source material;
an optical component to direct the high-powered laser beam to be incident upon the X-ray source material, wherein the X-ray source material generates X-ray radiation upon being energized by the high-powered laser; and
one or more components of a test system positioned to receive the X-ray radiation generated from the X-ray source material.

8. The system of claim 7, further comprising:
a beam splitter to separate the high-powered laser beam into a plurality of laser beams to be delivered to the sources in an appropriate vacuum;
a plurality of optical components to direct the plurality of laser beams toward a plurality of X-ray producing sources to generate X-ray radiation from each of the plurality of sources; and
wherein the test system is positioned in a vacuum to receive the X-ray radiation generated by the plurality of sources.

9. The system of claim 7, wherein the high-powered laser is produced by an excimer laser system.

10. The system of claim 7, wherein the source material comprises at least one of a mixture of one or more noble gases or a metallic foam.

11. The system of claim 7, wherein the high-powered laser comprises a wavelength in the range of 190-260 nanometers.

12. The system of claim 7, wherein the high-powered laser comprises a wavelength in the range of 247-250 nanometers.
